(19) United States
(12) Patent Application Publication
(10) Pub. No.: US 2024/0326061 A1
(43) Pub. Date: Oct. 3, 2024

(54) CRUSHER FOR COMMINUTING CHIPS

(71) Applicant: THOMAS SPYRA, WAIBLINGEN (DE)

(72) Inventor: THOMAS SPYRA, WAIBLINGEN (DE)

(21) Appl. No.: 18/618,183

(22) Filed: Mar. 27, 2024

(30) Foreign Application Priority Data
Apr. 2, 2023 (DE) 10 2023 108 393.7

(51) Int. Cl. B02C 15/00

(52) U.S. Cl. CPC B02C 15/003

(57) ABSTRACT

A crusher for comminuting chips including a hopper for loading chips, a fine breaking mechanism for breaking the chips into fine chips, and a chip discharge. The chips loaded the hopper may include coarse particles. The fine breaking mechanism includes fixed external teeth and a rotary inner cutter head with blades. The fixed external teeth are arranged on at least two segments movable in such a way that they can be moved away from the cutter head when a coarse particle enters the fine breaking mechanism so the coarse particle can pass through the fine breaking mechanism. The segments of the fine breaking mechanism can assume a cleaning position in addition to the operating position, wherein, when the segments are in the cleaning position, an intermediate space is provided between a base plate and a cover plate allowing access in the horizontal direction to the cutter head.

### CROSS-REFERENCE TO RELATED APPLICATIONS

This application claims the priority of German Application No. 10 2023 108 393.7 filed Apr. 2, 2023. The said German Application No. 10 2023 108 393.7 is incorporated herein by reference in its entirety as though fully set forth.

### BACKGROUND OF THE INVENTION

The invention relates to a crusher for comminuting chips according to the claims.

Such crushers are used in particular in order to comminute chips produced during machining operations such as turning or milling, for example. The comminuted chips, which are also referred to as fine chips, can be fed, for example, to a centrifuge in order to remove liquids adhering to the chips, for example in the form of cooling lubricants. In this case, the crusher, together with a centrifuge, can be part of a plant for processing chips.

The chips fed to a crusher may include coarse particles, for example iron parts, screws, nuts, or tools. Such coarse particles can become stuck in the crusher and block the crusher. The blockage then needs to be removed, in particular by hand, which leads to a longer downtime of the crusher, and therefore of a plant using the crusher to process chips.

Such a crusher can also be used to crush other particles, for example pieces of wood, plastic parts, or similar materials. Its use is not limited to crushing chips, in particular to crushing metal chips.

DE 10 040 602 A1 proposes a crusher for comminuting chips in which blockage of the crusher by coarse particles is to be prevented. The crusher described therein comprises a hopper for filling chips, a fine breaking mechanism for breaking the chips into fine chips, and a chip discharge. The hopper is arranged above the fine breaking mechanism in the vertical direction, and the fine breaking mechanism is arranged in the vertical direction above the chip discharge. The chips filled via the hopper can have coarse particles as described above. The fine breaking mechanism is provided with fixed external teeth and a rotary inner cutter head with blades. The cutter head of the fine breaking mechanism is designed and, when the segments are in an operating position, arranged with respect to the fixed teeth in such a way that chips fed to the fine breaking mechanism when the cutter head is rotating are broken into fine chips through the interaction of the blades and the fixed teeth. The fixed teeth of the fine breaking mechanism are arranged on at least two segments movable in such a way that they can be moved away from the cutter head when a coarse particle enters the fine breaking mechanism so the coarse particle can pass through the fine breaking mechanism. When viewed from the top, the shape of each segment is that of an arc of a circular ring. The segments of the fine breaking mechanism are arranged in an intermediate space between a base plate and a cover plate arranged in the vertical direction above the base plate. The chip discharge is designed and arranged so that the fine chips leave the crusher from the fine breaking mechanism via the chip discharge. For reliable operation of the crusher, the segments of the fine breaking mechanism must move away reliably from the cutter head when a coarse particle enters the fine breaking mechanism to allow the coarse particle to pass.

In light of this, the object of the invention in particular is to propose a crusher that enables long operating times without the necessity of disassembling the crusher for cleaning and maintenance purposes. According to the invention, the object is achieved by a crusher having the features of the claims.

### BRIEF SUMMARY OF THE INVENTION

The crusher for comminuting chips according to the invention comprises a hopper for filling the chips, a fine breaking mechanism for breaking the chips into fine chips, and a chip discharge. The hopper is arranged above the fine breaking mechanism in the vertical direction, and the fine breaking mechanism is arranged in the vertical direction above the chip discharge. The chips filled via the hopper may include coarse particles. The fine breaking mechanism is provided with fixed external teeth and a rotary inner cutter head with blades. The cutter head of the fine breaking mechanism is designed and arranged with respect to the fixed teeth in such a way that chips fed via the hopper to the fine breaking mechanism when the cutter head is rotating are broken into fine chips through the interaction of the blades and the fixed teeth. The fixed teeth of the fine breaking mechanism are arranged on at least two segments movable in such a way that they can be moved away from the cutter head when a coarse particle enters the fine breaking mechanism so the coarse particle can pass through the fine breaking mechanism. The segments of the fine breaking mechanism are arranged in an intermediate space between a base plate and a cover plate arranged in the vertical direction above the base plate. The chip discharge is designed and arranged so that the fine chips leave the crusher from the fine breaking mechanism via the chip discharge. According to the invention, the segments of the fine breaking mechanism can assume a cleaning position in addition to the operating position, wherein, when the segments are in the cleaning position, an intermediate space is provided between the base plate and the cover plate allowing access in the horizontal direction to the cutter head.

This means that when the segments of the fine breaking mechanism are in the cleaning position, the surface of the base plate, which extend horizontally in particular, and of the cover plate, which runs horizontally in particular, as well as surfaces of the segments of the fine breaking mechanism, which are oriented in the direction of the aforementioned intermediate space, can be cleaned without dismantling the crusher, i.e. without removing the cover plate, and, in particular, allowing contamination in the form of metal dust and small chips to be removed. Over time, said contaminants can make it difficult or even impossible to move the segments away from the cutter head to allow a coarse particle to pass. It is also possible for one or more chips to become jammed between a segment of the fine breaking mechanism and the base plate or the cover plate, making it difficult to move the segment away from the cutter head. Such chips are easy to remove when the segments of the fine breaking mechanism are in the cleaning position. The described cleaning position of the segments and the resulting accessibility of the intermediate space between the base plate and the cover plate allow the segments of the fine breaking mechanism to be reliably removed from the cutter head without disassembling the crusher. This enables long-term and reliable operation of the crusher.

To move the segments of the fine breaking mechanism from their operating positions to their cleaning positions, the segments are at least partially moved out of the intermediate space between the base plate and cover plate. They are moved without separating the base plate and the cover plate from one another. This means that the aforementioned intermediate space between the base plate and the cover plate is retained and is accessible from the horizontal direction up to the cutter head of the fine breaking mechanism. The intermediate space is restricted from below by an upward-facing surface of the base plate and from above by a downward-facing surface of the cover plate. Both surfaces can be accessed in the horizontal direction and thus cleaned. The segments can also be easily cleaned by moving the segments of the fine breaking mechanism at least partially out of the aforementioned intermediate space; in particular, the upward-facing and downward-facing surfaces of the segments are accessible and can thus be cleaned.

The chips filled into the hopper, including the coarse particles, reach the fine breaking mechanism due to gravity.

The fixed external teeth of the fine breaking mechanism are arranged in particular along a circular path in which the rotary cutter head is arranged concentrically. The cutter head is driven by a drive, in particular an electric motor. In particular, the aforementioned drive also drives a tearing arm of an optional coarse breaking mechanism, wherein in this case the cutter head and the tearing arm are arranged on a common shaft.

In particular, the fine breaking mechanism has between 4 and 10 fixed teeth, and the cutter head of the fine breaking mechanism between 4 and 10 blades. However, it can be provided with more or fewer fixed teeth and blades.

An inward, i.e. directed in the direction of the cutter head, restoring force is applied in particular to each of the segments of the fine breaking mechanism with the fixed teeth by means of an energy storage device, for example in the form of a spring or a pressure accumulator. The segments are thus brought or pressed to their operating positions. As soon as a coarse particle reaches the fine breaking mechanism, at least one segment is pressed outwards, and thus to a passing position, by the coarse particle against the restoring force of the energy storage device and is thus moved away from the cutter head so that the coarse particle can pass through the fine breaking mechanism. As soon as the coarse particle has left the fine breaking mechanism, the segments that were pressed outward to their passing positions are moved back into their initial position due to the restoring force of the energy storage device. In this case, the magnitude of the described restoring force can be adjusted according to the type of chips fed to the crusher.

It is also possible to detect a coarse particle using a sensor and, after a coarse particle has been detected, move at least one segment of the fine breaking mechanism outwards by means of an actuator and, after the coarse particle has passed, move it back to its initial position.

In an embodiment of the invention, the respective segments of the fine breaking mechanism are swivelably arranged around a vertical pivot axis. This allows the segments of the fine breaking mechanism to be simply swiveled out of the intermediate space between the base plate and the cover plate by pivoting them around their respective axes, and thus brought into their cleaning positions. Furthermore, the segments of the fine breaking mechanism can also be moved to their operating positions and passing positions simply by swiveling them. In particular, the pivot axis is arranged on one end of a segment.

In an embodiment of the invention, one end of each of the segments of the fine breaking mechanism opposite the respective pivot axis is pressed in the direction of the cutter head of the fine breaking mechanism by means of an energy storage device. The energy storage device thus acts on the respective segment of the fine breaking mechanism via the longest possible lever arm, and therefore must only apply the lowest possible force required to move the segment from its passing position back to its operating position. The energy storage device can thus be designed to be especially small and economical.

In an embodiment of the invention, the energy storage devices are arranged in the intermediate space between the base plate and the cover plate and can be removed from the intermediate space in the horizontal direction. The arrangement of the energy storage devices in the aforementioned intermediate space allows a compact design of the crusher and also allows the energy storage device to act directly on the respective segment. Furthermore, the energy storage devices in the aforementioned intermediate space are arranged so that they are protected from external influences. The ability to remove the energy storage devices in the horizontal direction from the aforementioned intermediate space allows the pressure accumulator to be removed from the intermediate space without having to remove the base plate and the cover plate. Furthermore, this creates space so that the segments of the fine breaking mechanism can be swiveled from their operating positions through their passing positions into their cleaning positions, and thus out of the aforementioned intermediate space, to enable access to the cutter head in the horizontal direction through the intermediate space.

The energy storage devices can be fixed in place in the aforementioned intermediate space, in particular by means of holders fixed to the outside of the crusher. When the crusher is ready for operation, i.e. when the segments of the fine breaking mechanism are in their operating positions or in their passing positions, the energy storage devices are fixed in place by the aforementioned holders. Fixing the energy storage devices from the outside enables them to be easily released, thus enabling easy removal of the energy storage devices from the intermediate space between the base plate and the cover plate.

The aforementioned holders are designed as metal tabs, for example, which are bolted on the outside of the crusher, in particular on the base plate and/or the cover plate. The inner side of a given energy storage device is then in contact with its respective metal tab and is therefore prevented from being pressed out of the aforementioned intermediate space. The metal tab therefore restrains the force acting in the direction of the operating position on the respective segment of the fine breaking mechanism.

In an embodiment of the invention, the chip discharge is provided with a discharge surface, which is designed and arranged such that the fine chips and coarse particles leaving the fine breaking mechanism fall onto the discharge surface and are conveyed out of the crusher. A scraper comprising at least one rotatable scraper arm for moving the fine chips after leaving the fine breaking mechanism to the discharge surface of the chip discharge is arranged between the fine breaking mechanism and the chip discharge. The entire discharge surface of the chip discharge is at a minimum distance from the scraper in the vertical direction of at least 100 mm, in particular 200 mm. In this manner, coarse particles passing through the fine breaking mechanism, in particular including elongated coarse particles, can be discharged from the crusher via the discharge surface of the chip discharge without the risk of the coarse particle becoming jammed between the fine breaking mechanism and the discharge surface. The jamming of a coarse particle in this manner would lead to a blockage of the crusher, which would then have to be remedied, in particular by hand.

The discharge surface of the chip discharge extends in the horizontal direction, in particular over the entire scraper, and can also protrude beyond the scraper. All the fine chips and coarse particles leaving the fine breaking mechanism therefore fall onto the discharge surface of the chip discharge. The discharge surface is designed in particular as a flat surface and is arranged in particular at an angle with respect to the vertical so that it is sloped. The entire discharge surface of the chip discharge is then arranged at a distance away from the scraper in the vertical direction.

The scraper can improve the discharge of fine chips and coarse particles from the crusher via the chip discharge. The scraper arm is driven in particular by the drive driving the cutter head of the fine breaking mechanism. In this case, the scraper arm and the cutter head are arranged on a common shaft. The scraper can have, in particular, more than one scraper arm, for example between 4 and 8 scraper arms.

In an embodiment of the invention, a coarse breaking mechanism with a rotatable tearing arm is arranged between the hopper and the fine breaking mechanism. The tearing arm extends in particular upwards, and its outer contour is adapted to the shape of the hopper.

The chips filled into the hopper then first reach the coarse breaking unit due to gravity, where they are torn into coarse chips by the tearing arm. They then fall into the fine breaking mechanism due to gravity. The coarse breaking mechanism is particularly advantageous when bundles of loosely packed chips are fed into the crusher. In a crusher without a coarse breaking mechanism, bundles of loosely packed chips may not reliably reach the fine breaking mechanism since they have a comparatively large volume and a low density.

The chips filled into the hopper can also pass directly to the fine breaking mechanism.

### BRIEF DESCRIPTION OF THE DRAWINGS

Further embodiments of the invention will become apparent from the description and the drawings. Exemplary embodiments of the invention are shown in simplified form in the drawings and explained in more detail in the subsequent description. The figures show the following:

FIG. 1 shows a side view of a crusher with a fine breaking mechanism for comminuting chips.

FIG. 2 shows a fine breaking mechanism with two movable segments in their operating positions.

FIG. 3 shows the fine breaking mechanism from FIG. 2 with one movable segment in its cleaning position.

FIG. 4 shows a fine breaking mechanism with three movable segments in their operating positions.

FIG. 5 shows the fine breaking mechanism from FIG. 4 with one movable segment in its cleaning position.

### DETAILED DESCRIPTION OF THE INVENTION

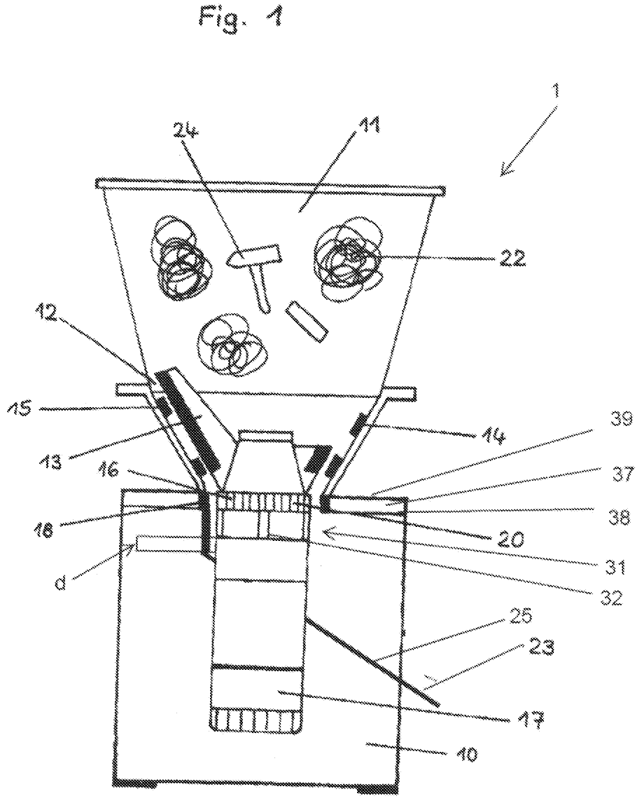

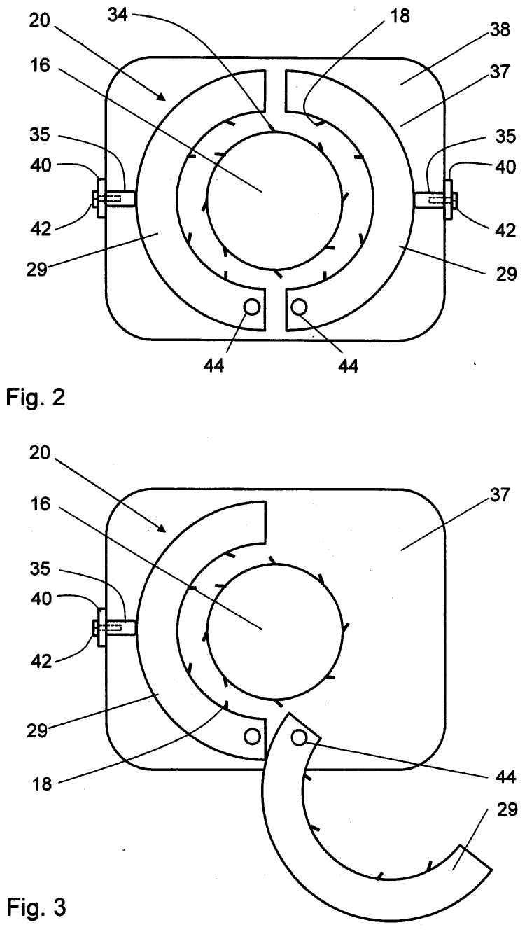

According to FIG. 1, a crusher 1 has a frame 10, on top of which a hopper 11 is arranged. A coarse breaking mechanism 12 comprising a tearing arm 13 and teeth 14, 15 arranged on walls of the hopper 11 is arranged in the hopper 11. The tearing arm 13 is driven by an electric motor 17 arranged vertically in the frame 10. A fine breaking mechanism 20 is located below the hopper 11 in the vertical direction. It comprises a circumferential cutter head 16 and fixed teeth 18. The cutter head 16 of the fine breaking mechanism 20 is also driven by the electric motor 17. The fixed teeth 18 are arranged on movable segments (29 in FIGS. 2 to 5), which are described in more detail in the descriptions of FIGS. 2 to 5. The fixed teeth 18, and thus the aforementioned movable segments, are arranged in an intermediate space 37 between a horizontal base plate 38 and a horizontal cover plate 39 arranged above the base plate 38 in the vertical direction.

The particles to be crushed, for example chips from machining operations or bundles of loosely packed chips 22, enter the hopper 11. The particles are detected by the tearing arm 13 and, through interaction with the teeth 14, 15 arranged on walls of the hopper 11 are first crushed into coarse chips until they can be fed to the fine breaking mechanism 20. Below the tearing arm 13, the coarse chips enter the fine breaking mechanism 20 and are processed there into fine chips. The fine breaking mechanism 20 is provided for this purpose with fixed external teeth 18 and a rotary inner cutter head 16 with blades 34. The cutter head 16 with the blades 34 is designed and arranged in relation to the fixed teeth 18 in such a way that, when the cutter head 16 rotates, the chips fed into the fine breaking mechanism 20 via the hopper 11 are broken into fine chips through the interaction of the blades 34 and the fixed teeth 18.

A scraper 31 with a plurality of rotatable scraper arms 32 is arranged below the fine breaking mechanism 20. The scraper 31 is also driven by the electric motor 17. Fine chips leaving the fine breaking mechanism 20 are moved by the scraper arms 32 to a chip discharge 23 arranged below the scraper 31 and placed in a transport container (not shown in the figure).

It is also possible that the crusher is not provided with a scraper. In this case, the chip discharge is arranged directly below the fine breaking mechanism.

The chip discharge 23 has a discharge surface 25 designed as a flat surface that extends in the horizontal direction over the entire fine breaking mechanism 20 or the entire scraper 31. The discharge surface 25 is at an angle with respect to the vertical so that it is sloped.

The entire discharge surface 25 of the chip discharge 22 is arranged at a distance away from the scraper 31 in the vertical direction, and thus also at a distance away from the fine breaking mechanism 20. The entire discharge surface 25 of the chip discharge 23 is at a minimum distance d from the scraper 31 in the vertical direction of at least 100 mm, in particular 200 mm.

If the crusher is not provided with a scraper, the entire discharge surface of the chip discharge has a minimum distance from the fine breaking mechanism in the vertical direction of at least 100 mm, in particular 200 mm.

It is also possible that the discharge surface of the chip discharge is located at a smaller distance or does not have a minimum distance from the fine breaking mechanism and/or from the scraper.

If a coarse particle 24, which can be in the form of a metal rod, a piece of steel, or a tool, for example, passes into the hopper 11 together with the chips, it will also be detected by the fine breaking mechanism 20. The fixed teeth 18 of the fine breaking mechanism 20 according to FIGS. 2 to 5 are arranged on two segments 29 movable in such a way that they can be moved away from the cutter head 16 when a coarse particle 24 enters the fine breaking mechanism 20 so the coarse particle 24 can pass through the fine breaking mechanism 20.

FIG. 2 shows a view from the top of the fine breaking mechanism 20 and the base plate 38 without the cover plate 39. Energy storage devices 35 in the form of pressure accumulators are each fixed in the intermediate space 37 by a respective holder 40 in the form of a metal tab. Each of the holders 40 are fastened to the outside of the base plate 38 and the cover plate 39 by means of two screws 42 and thus fixed in place on the crusher 1. This also means that the energy storage devices 35 are fixed to the outside of the crusher 1.

When viewed from the top, the shape of each segment 29 is that of a 180° arc of a circular ring. The segments 29 are arranged relative to one another such that together they form a ring, wherein their adjacent ends are spaced apart from one another. Each of the segments 29 is swivelably arranged on a vertical pivot axis 44 arranged at the end of the respective segment 29. The pivot axis 44 is designed, for example, as a vertical bolt that extends through a corresponding recess in the segment 29.

The segments 29 and the energy storage devices 35 are arranged so that the corresponding energy storage device 35 acts centrally between the two ends of the segment 29 and presses the segment 29 inwards in direction of cutter head 16, and thus into the operating position of the segment 29 shown in FIG. 2. As soon as a coarse particle 24 enters the fine breaking mechanism 20, at least one segment 29 is pressed outwards by the coarse particle 24 against the restoring force of the respective energy storage device 35 and swivels outwards from the pivot axis 44. The segment 29 is moved away from the cutter head 16 and brought into its passing position such that the coarse particle 24 can pass through the fine breaking mechanism 20. As soon as the coarse particle 24 has dropped down and out of the fine breaking mechanism 20 in the direction of the chip discharge 23, the outwardly pressed segments 29 swivel inwards again about the pivot axis 44 due to the restoring force of the respective energy storage device 35 to their initial positions shown in FIG. 2, and thus to their operating positions.

The segments 29 can also assume an additional position in the form of a cleaning position in addition to the operating position and the passing position. FIG. 3 shows the right segment 29 of the fine breaking mechanism 20 in its cleaning position. To move the right segment 29 from the operating position shown in FIG. 2 to the cleaning position shown in FIG. 3, the energy storage device 35 associated with the right segment 29 is removed. To remove the energy storage device 35, both screws 42 and the holder 40 must be removed. Afterwards, the energy storage device 35 can be pulled in horizontal direction out of the intermediate space 37 and thus removed. The segment 29 can then be swiveled outwards about the respective pivot axis 44 to the cleaning position shown in FIG. 3. This allows access in the horizontal direction through the intermediate space 37 up to the cutter head 16 for cleaning. In addition, the right segment 29 located in the cleaning position can also be cleaned.

After completing cleaning, the right segment 29 is swiveled back to its operating position and the respective energy storage device 35 is reinstalled and fixed in place again. The left segment 29 can then be moved to its cleaning position in the same manner. Similarly, the left segment 29 can also be swiveled to its cleaning position and then back to its operating position.

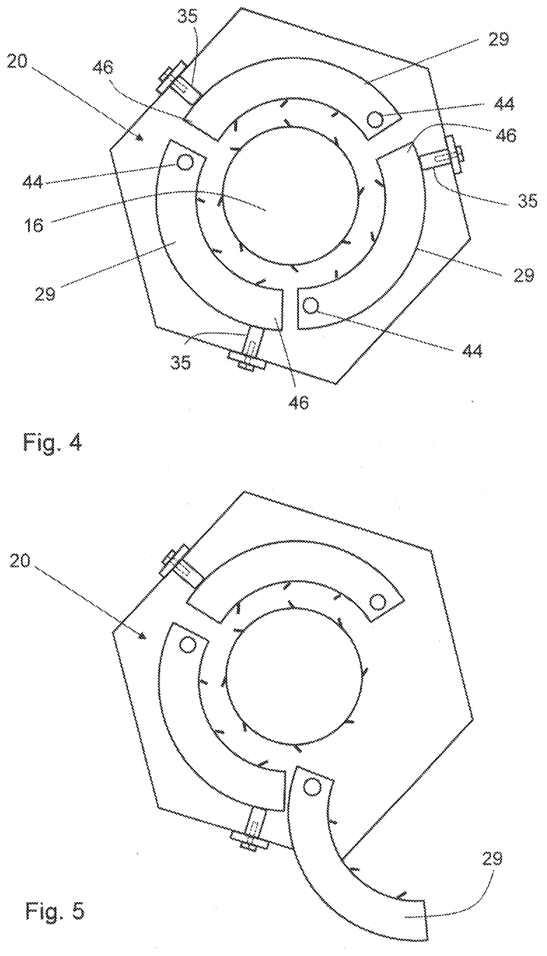

According to FIGS. 4 and 5, the fine breaking mechanism 20 can also be provided with three movable segments 29 instead of two as shown in FIGS. 2 and 3. The fine breaking mechanisms 20 in FIGS. 2 and 3 and/or 4 and 5 are otherwise very similar in design, for which reason only the differences between the fine breaking mechanisms will be described.

When viewed from the top, the shape of each segment 29 of the fine breaking mechanism 20 according to FIGS. 4 and 5 is that of a 120° arc of a circular ring. The segments 29 are arranged relative to one another such that together they form a ring, wherein their adjacent ends are spaced apart from one another. Each of the segments 29 is also swivelably arranged on a vertical pivot axis 44 arranged at the end of the respective segment 29.

The segments 29 and the energy storage devices 35 are arranged so that the respective energy storage device 35 acts on one end 46 of the segments 29 of the fine breaking mechanism 20 opposite the particular pivot axis 44 so that the segment 29 is pressed in the direction of the cutter head 16 of the fine breaking mechanism 20. FIG. 4 shows all three segments 29 of the fine breaking mechanism 20 in their operating positions.

FIG. 5 shows the right segment 29 of the fine breaking mechanism 20 in its cleaning position. The change in position from the operating position shown in FIG. 4 to the cleaning position shown in FIG. 5 proceeds in the same manner as described above for the change in position of the right segment from its operating position in FIG. 2 to its cleaning position in FIG. 3. The other two segments 29 in FIGS. 4 and 5 can be swiveled in the same manner to their cleaning positions and then back to their operating positions.

The fine breaking mechanism can also have more than three, for example four or five, movable segments with fixed teeth.

1. A crusher for comminuting chips comprising
a hopper (11) for loading the chips (22),
a fine breaking mechanism (20) for breaking the chips (22) into fine chips, and
a chip discharge (23),
wherein
the hopper (11) is arranged above the fine breaking mechanism (20) in the vertical direction and the fine breaking mechanism (20) is arranged above the chip discharge (23) in the vertical direction,
the chips loaded via the hopper (11) may include coarse particles (24),
the fine breaking mechanism (20) is provided with fixed external teeth (18) and a rotary inner cutter head (16) with blades (34),
the fixed teeth (18) of the fine breaking mechanism (20) are arranged on at least two segments (29) movable such that they can be moved away from the cutter head (16) when a coarse particle (24) enters the fine breaking mechanism (20) so the coarse particle (24) can pass through the fine breaking mechanism (20),
the segments (29) of the fine breaking mechanism (20) are arranged in an intermediate space (37) between a base plate (38) and a cover plate (39) arranged in the vertical direction above the base plate (38),
the cutter head (16) of the fine breaking mechanism (2) is configured and arranged in an operating position of the segments (29) with respect to the fixed teeth (18) such that chips (22) fed via the hopper (11) to the fine breaking mechanism (20) when the cutter head (16) is rotating are broken into fine chips through the interaction of the blades (34) and the fixed teeth (18),
the chip discharge (23) is configured and arranged so that the fine chips leave the crusher (1) from the fine breaking mechanism (20) via the chip discharge (23),
characterized in that
the segments (29) of the fine breaking mechanism (20) are swivelably arranged around a vertical pivot axis (44) and are configured to assume a cleaning position in addition to the operating position, wherein, when the segments (29) are in the cleaning position, an intermediate space (37) is provided between the base plate (38) and the cover plate (39) allowing access in the horizontal direction to the cutter head (16).

2. (canceled)

3. The crusher according to claim 1,
characterized in that
one end (46) of each of the segments (29) of the fine breaking mechanism (20) opposite the respective pivot axis (44) is pressed in the direction of the cutter head (16) of the fine breaking mechanism (20) by an energy storage device (35).

4. The crusher according to claim 3,
characterized in that
the energy storage devices (35) are arranged in the intermediate space (37) between the base plate (38) and the cover plate (39) and can be removed from the intermediate space (37) in the horizontal direction.

5. The crusher according to claim 4,
characterized in that
the energy storage devices (35) can be fixed in place in the intermediate space (37) by holders (40) fixed to the outside of the crusher (1).

6. The crusher according to claim 1,
characterized in that
the chip discharge (23) is provided with a discharge surface (25), which is configured and arranged such that the fine chips and coarse particles (24) leaving the fine breaking mechanism (20) fall onto the discharge surface (25) and are conveyed out of the crusher (1),
a scraper (31) comprising at least one rotatable scraper arm (32) for moving the fine chips after leaving the fine breaking mechanism (20) to the discharge surface (25) of the chip discharge (23) is arranged between the fine breaking mechanism (20) and the chip discharge (23), and
the entire discharge surface (25) of the chip discharge (23) is at a minimum distance (d) from the scraper (31) in the vertical direction of at least 100 mm, in particular 200 mm.

7. The crusher according to claim 1,
characterized in that
a coarse breaking mechanism (12) with a rotatable tearing arm (13) for breaking chips (22) is arranged between the hopper (11) and the fine breaking mechanism (20).
